(19) United States
(12) Patent Application Publication
(10) Pub. No.: US 2003/0041186 A1
(43) Pub. Date: Feb. 27, 2003

(54) Method for driving a data storage device

(76) Inventor: Hung-Pin Chen, Shijr City (TW)

Correspondence Address: RABIN & CHAMPAGNE, PC, 1101 14TH STREET, NW, SUITE 500, WASHINGTON, DC, 20005, US

(21) Appl. No.: 10/175,040

(22) Filed: Jun. 20, 2002

(30) Foreign Application Priority Data
Aug. 23, 2001 (TW) 90120768

(51) Int. Cl. G06F 3/00

(52) U.S. Cl. 710/5

(57) ABSTRACT

A driving method for a data storage device is provided, used for an application in a driving program. The driving program is executed in a computer system. When the operation system in the computer system is necessary to perform an access action to the data storage device, the operation system makes a request to the driving program. After the driving program performs an access action to the data storage device, it is reported to the operation system in response about the accomplishment of the request. If this request is a reading action, then the driving program can predict the data, which will be read by the operation in the next time of reading, and the data is pre-read from the data storage device and is stored into the memory device. In this manner, it can improve the data transmission efficiency of the data storage device.

This application incorporates by reference of Taiwan application Serial No. 090120768, filed Aug. 23, 2001.

### BACKGROUND OF THE INVENTION

1. Field of the Invention

The present invention relates to a method for driving a data storage device. More particularly, the present invention relates to a driving method using a manner to pre-read the data, so as to improve the transmission efficiency for a data storage device.

2. Description of Related Art

Currently, the peripheral devices of the computer are integrated together by several different types of bus, such as the integrated drive electronics (TDE) bus and the universal serial bus (USB), and so on. Wherein, the peripheral devices, which use the IDE bus, are called as the IDE devices. The IDE devices being commonly used includes hard disk drive, optical disc drive, and rewriteable optical disc drive, and so on. One of the essential part devices in the computer system is the data storage device, which is used to store the data or the program needed by the computer in operation. The data storage device includes, for example, hard disk drive or optical disc drive, in which the IDE hard disk drive is the most often being used as the data storage device.

The method to access the content of the IDE device includes the program input/output (PIO) mode and the direct memory access (DMA) mode. In the PIO mode, it is that the driving program is executed at the central processing unit and is responsive for transmitting the needed data. In this manner, it will therefore consume very much of resource in the central processing unit. In the DMA mode, then it is that the DMA controller is responsive for transmitting the needed data, in which the central processing unit is not involved in the process of transmitting the data. As a result, it can improve the using efficiency for the central processing unit.

As shown in FIG. 1, it is a drawing of flow ram, schematically illustrating a processing flow for the DMA controller. When the DMA controller receives a command for transmitting the data from the driving program, this control processing flow then starts. Wherein, the content of this requirement is filled in a DMA table by the driving program. The DMA table includes the read action or writing action with respect to this requirement, the address of read/write, and the size of the data. At first, the DMA controller, according to content filled in the DMA table, will execute the action of transmitting the data, such as reading the data from the IDE device or writing the data into the IDE device, as shown in the step 102. After then, after the data are completely transmitted out, the DMA controller will issue an interruption signal, to inform the driving program about that this command has been accomplished, as shown in the step 104.

Also referring to FIG. 2 at the same time, it is a drawing of flow diagram, schematically illustrating the processing flow for the conventional method by using the DMA mode to access the IDE device. At first, the driving program waits until the IDE device is ready, as shown in the step 202. After then, the driving program fills in the DMA table according to the requirement, and then issues a command to the DMA controller for transmitting the data, as shown in the step 204. Then, it enters the operation flow for the DMA controller. This driving program waits for the interruption signal that will be issued by the DMA controller after the data transmission is accomplished, as shown in the step 206. After the accomplishment for the DMA controller to transmit the data, an interruption signal is immediately issued to inform the driving program. After the driving program has received the interruption signal, is also informs the operation system about the accomplishment of the requirement for transmitting the data, as shown in the step 208.

Even though the method, which uses the DMA mode to access the data in the IDE device, can save the consumption of resource in the central processing unit during transmitting action, it still also takes a certain time in waiting for the pre-operations such as the waiting for a ready of the IDE device and the command issued by the DMA controller. Since the operation speed for the central processing unit and the memory device in the current computer system is faster and faster, the limitation of the access speed due to the IDE device would be the bottleneck for the operation speed in the computer system. In particular, the limitation due to the access speed on the hard disk drive has been more obviously resulting in the effect. Therefore, if the access speed for the IDE device can be greatly increased, then it will have a great amount of improvement for the operation speed in the computer system under the integrated operation.

### SUMMARY OF THE INVENTION

It is therefore an objective of the present invention to provide a driving method by using a way of pre-reading to improve the transmitting speed for the data storage device.

In accordance with the foregoing and other objectives of the present invention, a driving method for an IDE device is provided, used for an application in a driving program. The driving program is executed in a computer system. The computer system includes an IDE device, a direct memory access controller (hereafter is called DMA controller), and a memory device. The computer system is under a control by an operation system. When the operation system makes a request to the IDE device for an access, the operation system then issues a request to the driving program. After the driving program, according to this request, fills in a DMA table, then a command for transmitting the data is issued to the DMA controller. The DMA controller then, according to the DMA table for the request, performs an access action to the IDE device. The DMA table includes the indication of this requirement for reading or writing, the address of the data for the reading/writing, and the size of the data. After the DMA controller has accomplished the access to the IDE device, then an interruption signal is issued to the driving program. If the request is the intention for a read, then the driving program will judge whether or not it is necessary to perform a pre-reading action. If it is, then in the next a pre-read action is again performed at the address having been read. Since it usually has the space in continuity for accessing the IDE device by the operation system, then a certain part of data can be pre-read beforehand and stored in the memory device. When the operation system again issues the request for the next time, the requested data has been already pre-read beforehand and stored in the memory device. It is not necessary to make the access action to the IDE device.

The driving method includes the following steps: (a) judging whether or not the request is a read request. If it is then the process performs the step of (b). If it is not, then it performs a writing process. In the step of (b), it is judged whether or not the needed data by the request has been written into the memory device. If it is, then the step of (c) is performed. If it is not, then the step of (d) is performed. In the step of (c), the needed data by the request stored in the memory device is reported to the operation system and the request is accomplished, and the driving method goes to an end. In the step of (d), it is waiting until the IDE device is ready, then the step of (e) is performed. In the step of (e), according to the request, the DMA table is filled in, and then a command of transmitting the data is then issued to the DMA controller. After then, the step of (f) is performed. In the step of (f), when the DMA controller has accomplished the command, it will issue an interruption signal. After the interruption signal is received, the step of (g) is performed. In the step of (g), it is checked whether or not a pre-read flag has been set to be a first value. If it is, then the step of (j) is performed. If it is not, then the step of (h) is performed. In the step of (h), the operation system is informed about the accomplishment of the request, and then the step of (i) is performed. In the step of (i), it is checked whether or not a pre-reading process is necessary to be performed. If it is then the step of (k) is performed. If it is not, then the step of (j) is performed. In the step of (j), the pre-reading flag is set to be a second value, and the driving method goes to an end. Then, in the step of (k), the pre-reading flag is set to be the first value and the address of the pre-reading and the size of the pre-reading are filled into the DMA table. After then, a command is issued to the DMA controller for transmitting the data, and then the step of (t) is performed.

In the foregoing method, when the pre-reading flag is set to the first value, it indicates that the IDE device is performing the action of the pre-reading. When the pre-reading flag is set to the second value, it indicates that the IDE device is not performing the action of the pre-reading.

In accordance with another objective of the present invention, a driving method for a data storage device is provided, used for an application in a driving program. The driving program is executed in a computer system. The computer system includes a data storage device and a memory a memory device. The computer system is under the control of an operation system. When the operation system is necessary to perform an access action to the data storage device, the operation system the makes a request to the driving program. The driving program, according to the request, fetches the needed data from the data storage device. This request is either a request of reading or a request of writing. The driving method includes the following steps. At first, the request issued from the operation system. Then, according to the request, the data is accessed. After then, the operation system is informed about the accomplishment of request. And then, selectively it is pre-read about the data from the data storage device.

### BRIEF DESCRIPTION OF DRAWINGS

The invention can be more fully understood by reading the following detailed description of the preferred embodiments, with reference made to the accompanying drawings, wherein:

FIG. 1 is a drawing of flow ram, schematically illustrating a processing flow for the DMA controller;

FIG. 2 is a drawing of flow diagram, schematically illustrating the processing flow for the conventional method by using the DMA mode to access the IDE device;

FIG. 3 is a drawing of flow diagram, schematically illustrating the driving process of an IDE device, according a preferred embodiment of the present invention; and

FIG. 4 is a drawing of flow diagram, schematically illustrating the process flow of the writing procedure based on the flow diagram in FIG. 3.

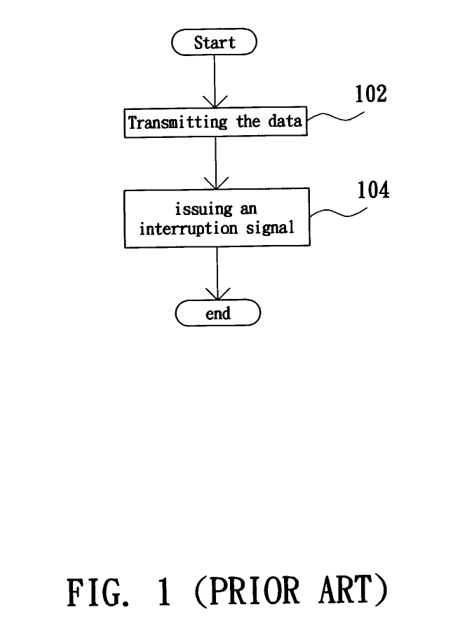

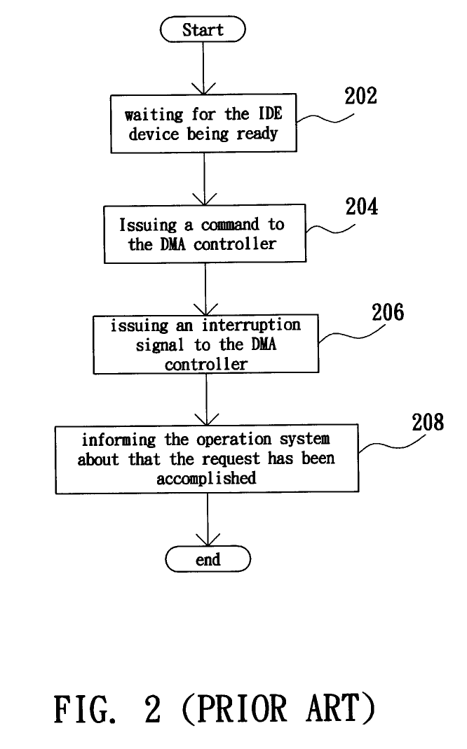

### DETAILED DESCRIPTION OF PREFERRED EMBODIMENTS

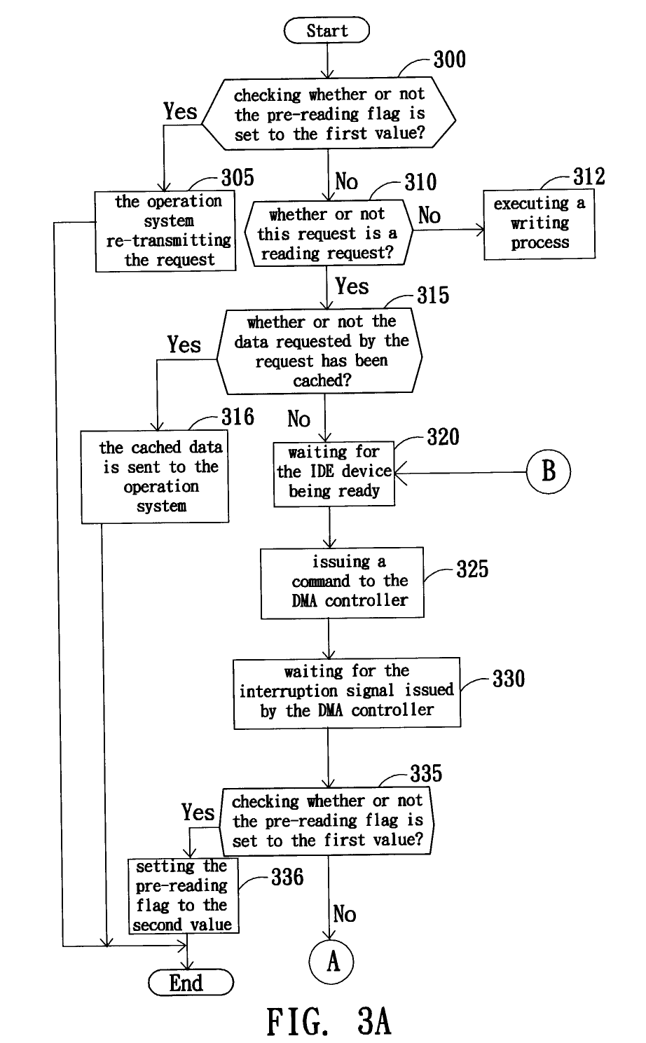

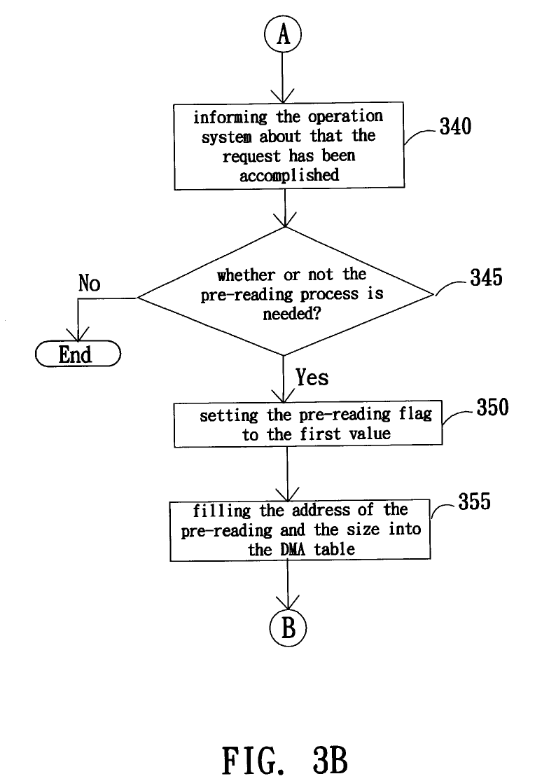

The driving method for a data storage device in the present invention is suitable for use in a data storage device. The data storage device includes, fore example, an integrated drive electronics (IDE) device. The IDE device is, for example, an IDE hard disk drive or an IDE optical disc drive. Now, the IDE device is taken as an example to introduce a preferred embodiment. As shown in FIG. 3, is a drawing of flow diagram, schematically illustrating the driving process of an IDE device, according to a preferred embodiment of the present invention. The driving method is used in an application on a driving program of an IDE device. The driving program is executed in a computer system. The computer system includes an IDE device, a direct memory access controller (hereafter is called DMA controller), and a memory device. The computer system is under control by an operation system. When the operation system makes a request to the IDE device for an access, the operation system then issues a request to the driving program. After the driving program, according to this request, fills in a DMA table, then a command for transmitting the data is issued to the DMA controller. The DMA controller then, according to the DMA table for the request, performs an access action to the IDE device. The DMA table includes the indication of this requirement for reading or writing, the address of the data for the reading/writing, and the size of the data. Since it usually has the space in continuity for accessing the IDE device by the operation system, that is, that data read from the IDE device in the consecutive two requests usually occupy the spaces at the adjacent locations, then a certain part of data can be pre-read beforehand and be stored in the memory device. When the operation system again issues the request for the next time, if the requested data has been already pre-read beforehand and stored in the memory device, then it is not necessary to make the access action to the IDE device. As a result, the reading efficiency can be improved.

The driving method includes the following steps. At first, after receiving the request issued by the operation system, it is judged whether or not a pre-reading action is just under performing, that is, the pre-reading flag is checked whether it is the first value, as shown in the step 300. If it is not, it indicates that the pre-reading action is not under performing at this moment, and then the step 310 is performed. If it is, then it indicates that the pre-reading action is under performing at this moment. Then the operation system issues again this request, as shown in the step 305. Then, the method goes to an end.

After then, it is judged whether or not the request is a read request, as shown in the step 310. If it is, then the process performs the step 315. If it is not, then it performs a writing process, as shown in the step 312. In the step 315, it is judged whether or not the needed data by the request has been written into the memory device. If it is, then the step 316 is performed. If it is not, then the step 320 is performed. In the step 316, the needed data by the request stored in the memory device is reported to the operation system and the request is accomplished, and the driving method goes to an end. In the step 320, it is waiting until the IDE device is ready. Then, after the DMA table is filled in, according to the request, then a command of transmitting the data is issued to the DMA controller, as shown in the step 325. After then, it is waiting for an interruption signal, which is issued after the DMA controller has accomplished the command, as shown in the step 330. After then, it is checked whether or not the pre-read flag has been set to be a first value, as shown in the step 335. If it is, then the step 336 is performed. If it is not, then the step 340 is performed. In the step 336, the pre-reading flag is set to be a second value, and the method goes to an end. In the step 340, the operation system is informed about the accomplishment of the request. And then, it is checked whether or not a pre-reading process is necessary to be performed, as shown in the step 345. If it is, then the step 350 is performed. If it is not, then the method goes to an end. The condition for a need to perform the pre-reading action is that the requested data is consecutive in space location to the previous data requested by the operation system. In other words, the occupation location on the IDE device for the requested data with respect to the current request is adjacent to the occupation location for the requested data with respect to the previous request by the operation system. In the step 350, the pre-reading flag is set to be the first value, and the address of the pre-reading and the size of the pre-reading are filled into the DMA table. In the next, a command is issued to the DMA controller for transmitting the data, as shown in the step 320.

Wherein, if the pre-reading flag is set to the first value, then it indicates that the IDE device is performing a pre-reading action, and if the pre-reading flag is set to the second value, then it indicates that the IDE device is not performing a pre-reading action. If the two consecutive data requested by the operation system have the space locations in continuity, then the pre-reading action can be performed. This pre-reading data and the read data with respect to the current request are consecutive in space. For example, the first request by the operation system is to read the content in 8 sectors after the sector 200, and the second request is to read the content in 8 sectors after the sector 208, then the data requested by these two requests are consecutive in space. This is then satisfying the condition for performing the pre-reading action. After then, the pre-reading action is performed. The address of the pre-reading action is then the sector 216, and the size of the pre-reading action is 32 sectors. The size of the pre-reading can be adjusted according to the different system.

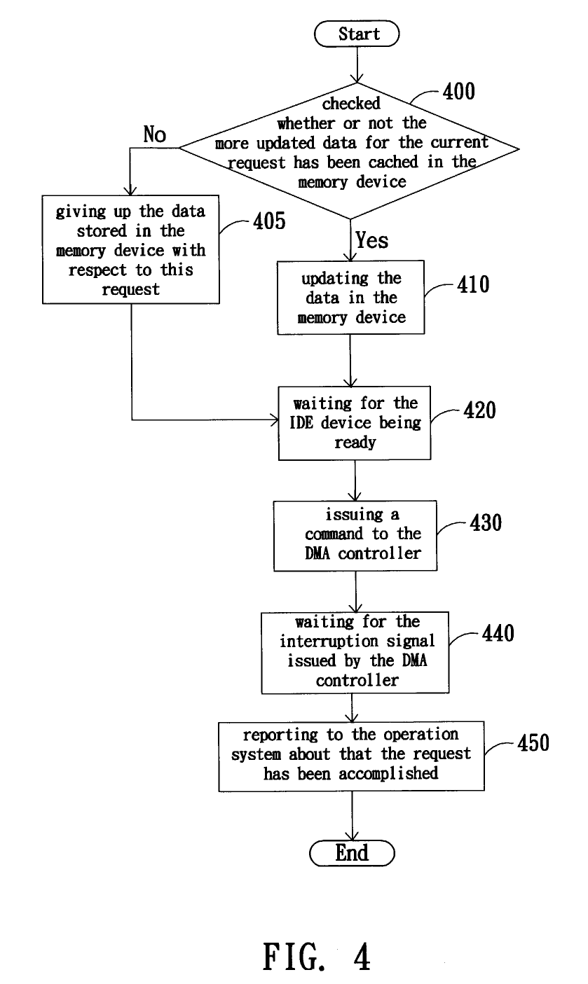

As shown in FIG. 4, it is a drawing of flow diagram, schematically illustrating the process flow of the writing procedure based on the flow diagram in FIG. 3. The write process includes the following steps. At first, it is checked whether or not the more updated data for the current request has been cached in the memory device, as shown in the step 400. If it is, then the data in the memory device is updated, according to this request, as shown in the step 410. If it is not, then the data stored in the memory device with respect to this request is given up, as shown in the step 405. It should be noted that the step 410 is not absolutely necessary, and it can be taken or omitted depending on the actual difference of the request. Next, it is waiting for the IDE device being ready, as shown in the step 420. After then, the DMA table is filled up, according to this request. A command is issued to the DMA controller for transmitting the data, as shown in the step 430. In the following step, it is waiting for an interruption signal, which is issued after the DMA controller has accomplished the command, as shown in the step 440. When the interruption signal has been received, then the accomplishment of the request is reported to the operation system, as shown in the step 450. Then, the process goes to an end.

It usually is consecutive in space for the operation system to access the IDE hard disk drive. If it pre-reads the data in the next consecutive space, then as the operation system issues a request again in the next time, if the data has been pre-read then it is not necessary to have the access action again to the IDE device. As a result, the data transmission efficiency for the IDE device can be improved.

In summary, the foregoing preferred embodiment of the present invention has disclosed the driving method for a data storage device, which uses the property that the data access action in the space location is consecutive for the operation system to access the data storage device. The pre-reading action is performed to pre-read the data in the data storage device, so that the transmission efficiency forth the data storage device can be effectively improved.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded in the broadest interpretation so as to encompass all such modifications and similar arrangements.

What is claimed is:

1. A method for driving an integrated drive electronics (IDE) device, suitable for use in a driving program, wherein said driving program is executed in a computer system, including an IDE device, a direct memory access (DMA) controller, and a memory device, wherein said computer system is under a control by an operation system, when said operation system performing an access action to the IDE device, said operation system issuing a request to the driving program, and after said driving program filling in a DMA table, according to the request, a command for transmitting said data being issued to the DMA controller, and said DMA controller performing said access action to the IDE device, according to the DMA table for said request, wherein said DMA table includes an data address and a data size of a data for reading/writing, said method comprising the following steps of:
(a) judging whether or not said request is a read request, wherein if it is, then performing said step of (b), and if it is not, then performing a writing process;
(b) judging whether or not said needed data by said request has been cached into said memory device, wherein if it is, then performing said step of (c), and if it is not, then performing said step of (d);
(c) reporting said needed data by said request and stored in said memory device to the operation system, and accomplishing said request, and then said driving method going to an end;
(d) waiting for said IDE device being ready, and then performing said step of (e);
(e) according to the request, filling in said DMA table, then a command of transmitting said data being issued to the DMA controller;
(f) waiting for an interruption signal that is issued when said DMA controller has accomplished said command, wherein after said interruption signal is received, then said step of (g) is performed;
(g) checking whether or not a pre-read flag has been set to be a first value, wherein if it is, then said step of (j) is performed, and if it is not, then said step of (h) is performed;
(h) informing said operation system about said accomplishment of said request, and then said step of (i) being performed;
(i) checking whether or not a pre-reading process is necessary to be performed, wherein if it is, then said step of (k) is performed, and if it is not, then said step of (j) is performed;
(j) setting said pre-reading flag to be a second value, and said driving method going to the end; and
(k) setting said pre-reading flag to be said first value and filling an address of pre-reading and a size of pre-reading into said DMA table, wherein after then, a command is issued to the DMA controller for transmitting said data, and then said step of (f) is performed,
wherein when said pre-reading flag is set to the first value, it indicates that said IDE device is performing a pre-reading action.

2. The driving method as recited in claim 1, wherein in said step of (a), said writing process comprises said following steps:
checking a more updated data for said current request having been cached into said memory device, wherein if it is, then said data in said memory device is updated, according to the request, and if it is not, then said data stored in said memory device with respect to this request is given up;
waiting for said IDE device being ready;
filling in said DMA table, according to the request, and then a command being issued to the DMA controller for transmitting said data;
waiting for an interruption signal, which is issued after said DMA controller has accomplished said command; and
reporting to the operation system about said accomplishment of said request.

3. The driving method as recited in claim 1, wherein in said step of (a), said writing process further comprises said following steps of:
updating said data stored in said memory device, according to the request;
waiting for said IDE device being ready;
filling in said DMS table according to the request, after then a command being issued to the DMA controller for transmitting said data;
waiting for an interruption that is issued by said DMA controller according to the command; and
reporting to the operation about that said request has been accomplished.

4. The driving method as recited in claim 1, wherein in said step of (a), said writing process further comprises said following steps of:
giving up said data stored in said memory device with respect to the request;
waiting for said IDE device being ready;
filling in said DMS table according to the request, after then a command being issued to the DMA controller for transmitting said data;
waiting for an interruption that is issued by said DMA controller according to said command; and
reporting to the operation about that said request has been accomplished.

5. The driving method as recited in claim 1, wherein before said step of (a), said driving method further comprises said following step of:
checking whether or not said pre-reading flag is at said first value, if it is, then said step of (a) being executed, and if it is not, then said operation system re-transmitting said request again, and said driving method going to the end.

6. The driving method as recited in claim 1, wherein said step of (i) comprises:
checking whether or not said data being needed by said request and said data being needed by said operation system in said previous time of request are consecutive in a space location, wherein if it is, then a pre-reading action is performed.

7. The driving method as recited in claim 1, wherein said IDE device is a hard disk drive.

8. The driving method as recited in claim 1, wherein said IDE device is an optical disc drive.

9. A driving method for an integrated drive electronics (IDE) device, suitable for use in a driving program, wherein said driving program is executed in a computer system, said computer system includes a data storage device and a memory device, said computer system is under a control by an operation system, when said operation system desires to perform an access action to the data storage device, said operation system then issues a request to the driving program, said driving program, according to the request, fetches a data stored in said data storage device, said request is one of a reading request and a writing request, said driving method comprising said following steps of:
(a) receiving said request issued by said operation system;
(b) accessing said data, according to the request;
(c) informing said operation system about that said request has been accomplished; and
(d) optionally performing a pre-reading process to read said data from said data storage device.

10. The driving method as recited in claim 9, wherein after said step of (a), said driving method further comprises said following step of:
checking whether or not said pre-reading process is currently performed, wherein if it is, then said operation system re-transmits said request, and if it is not, then said step of (b) is performed.

11. The driving method as recited in claim 10, wherein said step of checking whether or not said pre-reading process is currently performed comprises:
checking whether or not a pre-reading flag is set to a first value, wherein if it is, said it indicates that said pre-reading process is currently performed.

12. The driving method as recited in claim 9, wherein said step of (b) comprises:
checking whether or not said request is a reading request, and if it is, then performing said following steps of:
checking whether or not said data being requested has been cached to the memory device, if it is, then reporting said data, which is stored in said memory device and has been requested, to the operation system; and if it is not, then reading said data, which is requested, from said data storage device, and reporting to the operation system.

13. The driving method as recited in claim 9, wherein said step of (b) comprises:
checking whether or not said request is a writing request, and if it is, then performing said following steps of:
checking whether or not said data to be updated has been completely cached to the memory device, if it is, then updating said data in said memory device, according to the request; and if it is not, then giving up said data in said memory device that is relating to the request;
writing said data, which is needed to be updated by said request, into said data storage device; and
reporting to the operation system.

14. The driving method as recited in claim 9, wherein said step of (b) comprises:
checking whether or not said request is a writing request, and if it is, then performing said following steps of:
giving up said data stored in said memory device with respect to the request;
writing said data, which is needed to be updated by said request, into said data storage device; and
informing said operation system about that said request has been accomplished.

15. The driving method as recited in claim 9, wherein said step of (b) comprises:
checking whether or not said request is a writing request, and if it is, then performing said following steps of:
updating said data stored in said memory device, according to the request;
writing said data, which is needed to be updated by said request, into said data storage device; and
informing said operation system about that said request has been accomplished.

16. The driving method as recited in claim 9, wherein said step of (d) comprises:
pre-reading said data from said data storage device, if said request is a reading request, and said data being needed by said reading request and said data being needed by said operation system in said previous time of said reading request are consecutive in a space location.

17. The driving method as recited in claim 16, wherein said data being pre-read and said data being needed by said reading request are consecutive in a space location.
